(19) United States
(12) Patent Application Publication
(10) Pub. No.: US 2015/0134954 A1
(43) Pub. Date: May 14, 2015

(54) SENSOR MANAGEMENT SYSTEM IN AN IOT NETWORK

(71) Applicant: Broadcom Corporation, Irvine, CA (US)

(72) Inventors: John Stuart WALLEY, Ladera Ranch, CA (US); Nicholas ILYADIS, Merrimack, NH (US); Stephen Wilson BAILEY, Hong Kong (HK); Wael William DIAB, San Francisco, CA (US)

(73) Assignee: Broadcom Corporation, Irvine, CA (US)

(21) Appl. No.: 14/161,653

(22) Filed: Jan. 22, 2014

Related U.S. Application Data
(60) Provisional application No. 61/914,926, filed on Dec. 11, 2013.
(60) Provisional application No. 61/904,432, filed on Nov. 14, 2013.

(51) Int. Cl. H04L 29/06; H04L 12/24; H04W 12/06

(52) U.S. Cl. CPC H04L 63/08; H04W 12/06; H04L 41/0813
USPC 713/168

(57) ABSTRACT

A method for managing and reconfiguring multiple devices of a network includes registering a digital birth certificate based on a private key to a device of the plurality of devices. Authenticating and validating the device may be performed based on the private key. The device can be reconfigurable, and reconfiguration of the device includes one of a physical reconfiguration, a logical reconfiguration, or reconfiguration of a mode of operation of the device.

### CROSS-REFERENCE TO RELATED APPLICATIONS

This application claims the benefit of priority under 35 U.S.C. §119 from U.S. Provisional Patent Application 61/914,926 filed Dec. 11, 2013 and the U.S. Provisional Patent Application 61/904,432 filed Nov. 14, 2013, which are incorporated herein by reference in its entirety.

### TECHNICAL FIELD

The present description relates generally to sensors, and more particularly, but not exclusively, to a sensor management system in an internet of things (IOT) network.

### BACKGROUND

The internet of things (IOT) refers to a platform (e.g., network structure) such as an Internet-like network, which may link identifiable things (e.g., objects or people) and/or their virtual representations. For examples, sensors can be objects of an IOT network, which can be identifiable via radio-frequency identifications (RFIDs), addresses (e.g., IP addresses), or other identification means within the IOT or the Internet. Sensors of an IOT can be managed via a sensor management system. The management of the sensors of the IOT may include establishing and/or changing configuration, authentication process, and association of one or more sensors of the network. The management of the sensors of the IOT may further include performing and/or modifying calibration and or changing other attributes of one or more sensors.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a network environment 100 for implementing a system of interoperable devices in accordance with one or more implementations.

FIG. 2 illustrates an example of a device of a system of interoperable devices in accordance with one or more implementations.

FIG. 3 illustrates an example of a method of managing and reconfiguring a system of interoperable devices in accordance with one or more implementations.

FIG. 4 illustrates an example wireless communication device in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and can be practiced using one or more implementations. In one or more instances, well-known structures and components are shown in block diagram form in order to avoid obscuring the concepts of the subject technology.

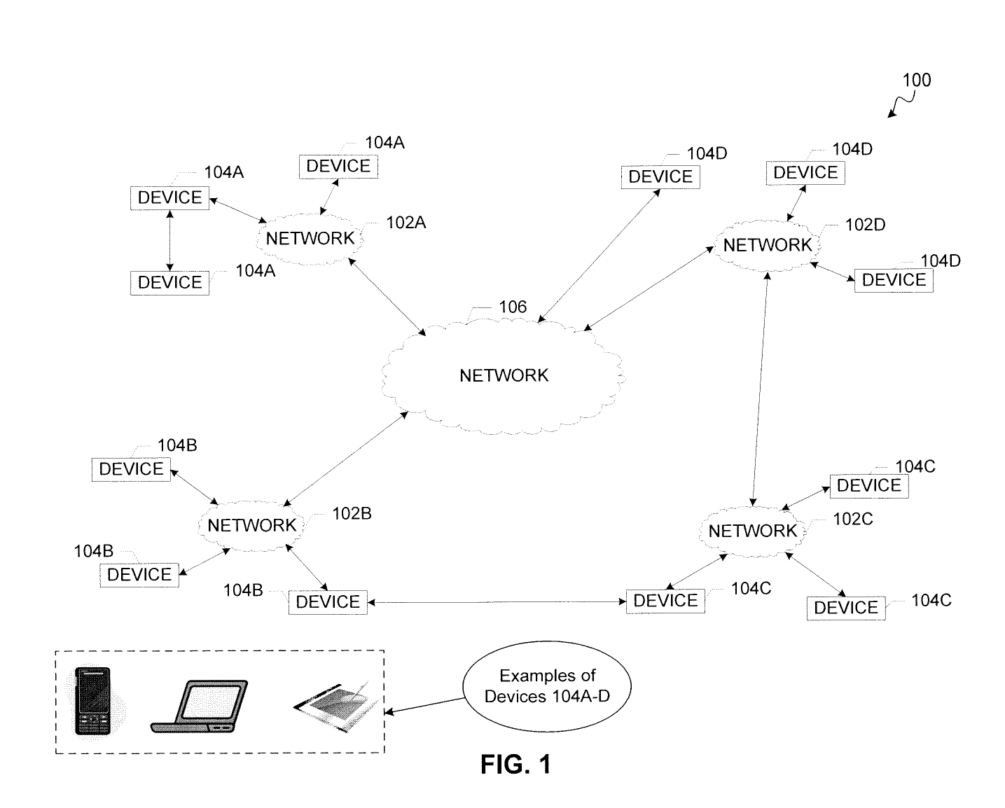

FIG. 1 illustrates an example of a network environment 100 for implementing a system of interoperable devices in accordance with one or more implementations of the subject technology. The network environment 100 includes the Internet, a private network, a network of things (IOT), or other networks. The example network environment 100 includes a number of electronic devices 104A-D and a number of networks 102A-D and 106. One or more of the devices 104A-D, such as the device 104A, can be any device capable of communicating with one or more other devices of the devices 104A-D, e.g. via wired or wireless communication. In one or more implementations, one or more of the devices 104A-D include, or may be, a sensor device that can be configured to measure a physical quantity and convert the physical quantity into a signal. Example of the sensor devices include temperature sensors, video cameras, audio recorders, motion sensors, humidity sensors, smoke detectors, various gas sensors, radiation monitors, and other sensors. In some aspects, the sensor device can be a smart sensor that includes, but is not limited to, processing logic such as one or more controllers or processors, memory, and communication interfaces. In some aspects, the devices 104A-D include, be embedded in, or be coupled to a portable device such as a portable communication device including a mobile phone, a laptop, a tablet, or any other communication device. The devices 104A-D can be communicably coupled to one or more of the networks 102A-D, 106 and/or to one or more other devices of the devices 104A-D.

One or more of the networks 102A-D and 106 include one or more wired or wireless network devices that facilitate device communication, such as router devices, switch devices, relay devices, etc., and/or include one or more servers. In one or more implementations, one or more of the networks 102A-D and 106, such as the network 106, may be, or may include, a cloud of computers. In one or more implementations, one or more of the networks 102A-D may be local area networks that communicatively couple one or more of the devices 104A-D. One or more of the networks 102A-D and 106 may be, and/or may include, one or more of a bus network, a star network, a ring network, a relay network, a mesh network, a star-bus network, a tree or hierarchical network, and the like. In one or more implementations, one or more of the networks 102A-D, 106 can be referred to as an IoT network and/or a machine-to-machine (M2M) network. In one or more implementations, one or more of the devices 104A-D can be referred to as an IoT device and/or an M2M device. In one or more implementations, there can be multiple paths between one or more of the devices 104A-D and/or one or more of the networks 102A-D.

One or more of the networks 102A-D and/or the devices 104A-D are able to autonomously communicate with one another (or other systems), e.g. M2M technologies. Thus, one or more of the devices 104A-D, such as action devices or actuators, can have access to data, e.g. via sensors, that can provide the devices 104A-D with information relevant to a user and/or the user's surroundings. Accordingly, the devices 104A-D can utilize available information to make decisions on behalf of the user. One or more of the devices 104A-D can be configured to make decisions on users' behalf based on one or more policies. The policies can be user generated or created through heuristics, e.g. a user never answers their phone from person X, a user always keeps their refrigerator stocked with eggs, etc.

An appropriate infrastructure may be required for an IoT network, such as one or more of the networks 102A-D and 106 to ensure that the necessary processing and sensing resources made available to the appropriate devices 104A-D without overwhelming the IoT network. Sensors and/or devices 104A-D can provide data to one or more local or disparate systems and or devices for open or closed loop decision making processes. The processing and/or decision making can be performed at multiple different levels of one or more of the networks 102A-D and 106, e.g. larger loops, with the processing and/or decision-making generally occurring as close to the sensor and/or device 104A-D as possible. In addition, a congestion notification mechanism can allow the edge of the IoT network, such as one or more of the networks 104A-D to signal that a wave of events is propagating through the network and that some load balancing should occur.

In one or more implementations, the IoT networks discussed herein may refer to one or more of the networks 102A-D and 106 and/or a portion of one or more of the networks 102A-D and 106. In one or more implementations, the sensors and/or devices discussed herein may refer to one or more of the devices 104A-D, or a portion of one or more of the devices 104A-D.

In an IoT network, it may be desirable to distribute intelligence and/or processing throughout the network, e.g. to minimize communications with a central data server and/or cloud and/or to reduce latency in decision making processes. An IoT network with distributed intelligence may include an intelligent edge, such that preprocessing and/or real-time control loops are performed in proximity of the edge devices. The IoT network with distributed intelligence may further include processing resources distributed at different nodes of the network, e.g. between the edge and a central server and/or cloud. For example, gateway devices, e.g. home gateways, can act as proxies between the edge and/or sensing devices and the data center and/or cloud resources.

If intelligence and/or processing resources are distributed throughout an IoT network, there may be multiple different processing resources that can be used to perform any given processing action. Thus, a mechanism that determines which resources perform which actions may be desirable. A resource capability adjudicator can determine where in the network, e.g. the appropriate processing resources and/or intelligence in the network, to perform various processing tasks and/or to perform various decision making tasks. The resource capability adjudicator can establish a decision loop for performing a decision making task and can map the decision loop to configure the network dynamically. The resource capability adjudicator can also provision network resources and/or compute resources for devices and/or services and can re-allocate provisioned resources when they are no longer in use.

Devices in an IoT network can have access to information from external systems that may be relevant to the configuration of the devices. Thus, it may be desirable for a device in an IoT network to configure itself, e.g. to configure itself to perform an action, based on information sensed by, or received by, the device. Devices in an IoT network can correlate relevant data from multiple disparate data sources to self-configure and/or perform actions intelligently, e.g. based on the correlated relevant data and/or policies. For example, a mobile device can set itself to a silent mode when a user enters a movie theater.

Devices in an IoT network can have access to information from external systems that may be relevant to the configuration of the devices. Thus, it may be desirable for a device in an IoT network to configure itself, e.g. configure itself to perform an action, based on information sensed or received by the device, e.g. in accordance with a policy. However, in one or more implementations, the device and/or the user of the device may not have the knowledge and/or capability to create and/or configure such a policy. A device in an IoT network can self-configure based on a policy and/or configuration settings of a similar device (e.g. a device running the same OS) that were implemented by an “expert user.” The expert user and the expert user's device can be identified and/or verified by a third party, e.g. a registrar, or can be organically identified through the network, e.g. a user who spends a significant amount of time configuring the device, a user whose device configurations and/or policies are copied, e.g. “followed”, by a large number of other users, etc.

As common devices such as appliances (e.g., refrigerators, etc.) become interconnected in an IoT network, a mechanism for the devices to self-initialize and/or register may be desirable. For example, some devices in an IoT network may not include a display and/or other configuration interface. A self-initializing and/or credentialing device in an IoT network can associate itself with a user, e.g. allow a user to establish ownership, based on one or more triggers. For example, the device can become associated with the user based on a credit card transaction when the device is purchased. Alternatively, or in addition, the device can become associated with the user by placing the device in a particular “pairing” location in the user's dwelling place, e.g. using Wi-Fi indoor location tracking, etc. The self-initialization of the device may not require any configuration of the device by the user. Once the device is associated with the user, the device can advertise its services and/or capabilities and/or network requirements to the IoT network, e.g. to other devices and/or applications in the IoT network that are associated with the user. The device can self-configure an initial configuration based on the configurations of surrounding devices. For example, the device can self-configure to utilize transmission protocols and/or standards that are being used by other devices associated with the user or in the user's home network. In addition, the device can request a translator and download protocols, as necessary, and the device can determine any drivers and/or protocols that may need to be downloaded to other IoT devices, e.g. for purposes of communicating with, and/or accessing services of, the device.

Some sensors in an IoT network may have temporary utility. As such, it may be desirable for such sensors to be reconfigurable for other purposes. A reconfigurable sensor or general purpose sensor can be reconfigured to perform a different behavior, provide a different output, etc. The reconfigurable sensor can be physically, or logically, rented, i.e. a rent-a-sensor. For example, the sensor itself can be physically rented, or the data feed provided by the sensor can be rented, i.e. logically renting the sensor. Furthermore, a general purpose sensor can be configured to provide different types of information to different user classes.

In view of the large number of sensors and/or devices that are expected to exist in IoT networks, it may be desirable to have a mechanism for revoking the authentication of a sensor, e.g. when the sensor is tampered with, or invalidating a sensor, e.g. when the sensor is providing inaccurate data or otherwise is malfunctioning. A revocable sensor authentication and/or validation system can be configurable to revoke a sensor's authentication and/or validation based on one or more policies, e.g. when the sensor is moved, when the sensor is determined to be providing inaccurate data, or through heuristics.

In view of the large number of sensors and/or devices that are expected to exist in IoT networks, it may be desirable to have a mechanism for determining when a sensor is providing inaccurate data or is otherwise malfunctioning. A node of an IoT network (or a built-in self-test (BIST) of a sensor) can determine that the sensor is providing inaccurate data when the data provided by the sensor varies significantly from data provided by other sensors that are expected to be providing similar data, e.g. temperature sensors that are located in the same geographic area. In order to minimize the amount of inaccurate data being transmitted through the IoT network, the sensor can be deactivated, or otherwise taken offline. The sensor can be remotely recalibrated, e.g. based on data received from the similarly situated sensors and can be remotely tested (e.g., using BIST) after recalibration. If the sensor passes the testing the sensor can be remotely reactivated.

Since IoT sensors and/or devices may often be associated with a particular person, there may be a need for a system for transferring ownership of an IoT sensor and/or device from one person to another, e.g. when the sensor and/or device is sold or otherwise transferred from one person to another. In a system for transferring ownership of an IoT sensor and/or device, a registrar or trusted authority can provide digital “birth certificates” for IoT sensors and/or devices, e.g. including a private key.

In view of the large number of sensors and/or devices that are expected to exist in IoT networks, there can be significant complexity associated with managing such devices. Thus, a system for managing devices and/or sensors in an IoT network may be desirable. A system for managing sensors in an IoT network can manage a group of sensors, e.g. sensors associated with a user, sensors associated with an intranet, etc. The management system can provide location information, e.g. for industrial sensors and/or can utilize an API that is location-based.

Since IoT devices may include a diverse set of disparate devices, it may be desirable to have a universal vocabulary for communicating with and/or between the devices. A system that has a universal vocabulary, or basic machine-to-machine language capabilities, can allow disparate devices to communicate with one another, as well as allowing users to communicate with the devices. For example, the vocabulary can facilitate communication of an instruction and/or action by a human to a device, e.g. in plain English phrases or through some other form of abstraction. The vocabulary can be scalable such that new additions can be added to the vocabulary, e.g. for more complex actions. The system may further include translators for communicating with legacy devices. In one example, the vocabulary may be, or may include, an STN model for IoT devices.

Since different IoT networks may not be federated or otherwise capable of communicating with one another, a mechanism for enabling a device to communicate across different IoT networks may be desirable. A portable smart agent can reside in one or more IoT networks and can authenticate and/or federate across disparate IoT networks; i.e., the smart agent can exist across disparate IoT networks in a federated way. Thus, the smart agent is able to communicate with devices and/or networks with a common trust.

Devices in an IoT network can generate a large amount of data, some of which may be redundant or of low value. Thus, a mechanism that enables filtering of low value or redundant data may be desirable. A pre-conditioning and/or pre-classifying agent can pre-classify and/or pre-condition and/or filter and/or aggregate data being generated in an IoT network such that high quality and/or value data can be distilled from low-quality and/or high-value data in the IoT network. In addition, the agent can identify data that should be pre-emptively cached based on the location of consumers of the data and the agent can cause the data to be pre-fetched and cached at a network node.

Devices in an IoT network can provide different sensor data at different times and/or in different formats. Thus, there may be a need for a malleable application that can adapt to the data that is being provided by devices at any given time. A reconditioning agent can recondition, or reconfigure, an application based on the data that is being provided to the agent by one or more sensors in an IoT network. For example, an application can be configured to provide information X based on received sensor data, but the available sensor data may not include information X, or information from which information X is derivable. In this instance, the reconditioning agent can reconfigure the application to provide information Y (which may be the closest available information to information X) based on data received from the sensors.

Devices in an IoT network can generate a significant amount of data that may be undecipherable or unusable by an average user and/or an average device. An expert agent, e.g. commercial entities, can provide decision making services for a user based on information generated by devices that are associated with the user, e.g. medical decisions. An expert agent can also perform a commercial pre-classifying and preconditioning of data generated by devices that are associated with a user.

The behavior of a user can affect the configuration and/or operation of devices associated with the user. A personal agent can continually observe and/or learn a user's behavior over time and can use the learned behavior of the user for future decision making processes, e.g. to control and/or configure devices that are associated with the user. The personal agent can adapt policies that are associated with the devices of the user based on the learned behavior of the user.

As common devices become interconnected in IoT networks, it may be desirable to simplify the commercial model and/or technology development for the devices. A technology platform can be provided for simplifying technology development of devices in an IoT network and increasing the velocity of innovation of such devices.

Since an IoT network may include multiple disparate sensors that provide multiple streams of data, it may be difficult to simulate an IoT network and the generated data streams, e.g. for application development and/or testing purposes. An IoT application development platform can include middleware that allows users to access live datasets from sensors without disturbing live agents and/or programs that are accessing the data. Access to the live datasets can greatly reduce the application development complexity and can allow for thorough testing of applications and/or devices before they are released to market. In some instances, the middleware may include anonymizing agents that remove any user identifiable data from the live datasets. The end users can also be given control of whether data from their devices can be used for application development purposes. The application development platform mar also include a simulation environment that can be used to score applications and may be used to simulate software running on different types of devices in the IoT network.

Since the number of sensors in IoT networks are expected to increase significantly, the number of device addresses that can be provided under current network address systems and/or techniques may quickly be exceeded. In addition, the structure of current network address systems may not be well-suited for devices in an IoT network, e.g. devices that can have spatial associations. In a location and/or capability based address system, devices can have addresses that are indicative of their location and/or capabilities, e.g. geospatial addresses, content-addressable addresses, addresses that are a quantization of the longitude and/or latitude of the devices, etc. In this manner, devices can be addressed based on their geographic and/or spatial location, e.g. to retrieve data from all sensors located within 10 feet of a user. Similarly, devices can be addressed based on their capabilities, classes, domains, etc., e.g. retrieve all temperature sensor data within a mile of a user. Alternatively, or in addition, data generated by the devices can be geo-tagged using the geospatial addresses, e.g. by the devices and/or by network nodes, to identify the locations where the data was generated and/or to identify the locations of the network nodes that the data passed through.

In view of the large number of data generating sensors and/or devices that are expected to exist in IoT networks, for any given application a significant amount of the generated data can be noise, and only a small amount of the data can be useful. In a system for reducing verbosity of information in an IoT network, sensors and/or intermediary devices can be configured to only transmit sensor data at certain intervals, e.g. when the data is changing. The system can further utilize the rate that the data is changing to determine how often updates are sent.

In some instances, users may wish to simultaneously view and/or interact with data across multiple disparate IoT networks. For example, a doctor may wish to view and/or interact with an MRI from his home, while a radiologist views and/or interacts with MRI in a hospital, etc. A point-to-multipoint communication system in an IoT network can determine, at each network node, how to transmit information to the IoT networks connected to the node, e.g. broadcast, multicast, etc. The system can separate the information being transmitted into layers and may only transmit the layers that have changed when updates occur. The system can also establish a global clock for the application that is communicating the information, since the information is communicated over multiple disparate networks that can each have their own clocks and/or timing mechanisms.

In view of the large number of sensors and/or devices that are expected to exist in IoT home networks, and the associated complexity of managing and/or communicating with such devices, it may be desirable to include an intermediary device, such as a home gateway, to act as a proxy for the IoT home network. A gateway device for a home IoT network can receive data from sensors in the network and transmit the data to applications, agents, devices, etc. In order to conserve network resources, the gateway device can cache data received from multiple devices and can transmit the data in aggregate, may transmit the data only when it is requested, or may transmit the data during off-peak hours. The gateway device can also implement privacy control for the sensors and/or devices in the home gateway, such as datagram based privacy. The gateway device can also anonymize sensor data, e.g. for transmission to applications and/or devices that are not authorized to receive identifiable data associated with the user. The gateway device can emulate the IoT devices in the home network such that the devices appear to always be connected, even though the devices can be sleeping or in a low-power mode, e.g. the gateway can query the devices when necessary. The gateway device can also control and/or filter the data that is provided to the outside network, e.g. to reduce redundant data. The gateway device (or other intermediary device) can implement an abstraction layer of what data can be associated with a user and what cannot.

Since properties and/or addressing of IoT sensors can be location based, it may be desirable for an IoT network to determine when an IoT sensor has been moved or otherwise tampered with. If a node of an IoT network determines that a sensor has been moved, the level of security associated with the sensor can be changed, e.g. based on the amount and/or distance that the sensor has been moved. For example, the authentication of the sensor can be revoked if the sensor is moved a short distance, while the sensor may be remotely deactivated if the sensor moves a longer distance. The sensor may include a mechanism that detects when the sensor is moved and/or one or more nodes in the IoT network can determine that the sensor has moved based on positioning mechanisms.

It may be desirable for sensor data that is generated in an IoT network have a time association, e.g. so that the data can be presented to actuator devices and/or processing devices at specific time intervals. However, some “dumb” sensor devices may not include timing and/or synchronization mechanisms. A system for time synchronizing sensor devices can append a timestamp to any data that is generated by sensors. For example, sensors that include timing mechanisms can self-synchronize with the IoT network and append timestamps to generated data, while a proxy device, such as a gateway device, can synchronize with the IoT network and append timestamps to data generated by “dumb” sensors and/or devices.

As the number of IoT devices increases, there can be one or more commercial markets for the information generated by the IoT devices. A revenue generation system for an IoT network can implement a subscriber based system for receiving data feeds from IoT devices. For example, an online marketplace can enable end users (or some higher level entity) to sell information from IoT sensors and/or devices to third parties, e.g. using a subscriber model, an auction model, etc.

In a machine-to-machine communication network, the security and/or privacy of any application and/or communication may be dependent on the location of all of the devices and/or sensors involved in the application and/or communication, e.g. not only the end-user device. A device in an IoT network can be configured to allow the privacy and security policy for an application to be set based on the collective locations of all of the devices and/or sensors in the IoT network that are utilized by the application, e.g. sensors from which data is retrieved, network devices that are in the communication path, etc. Furthermore, the device can allow a user to limit the privacy changes to the device based upon the location of the device in the IoT network. The privacy and/or security can be set by the user associated with a device, e.g. the owner, and the privacy and/or security can be unique for a data type, e.g. not for a physical channel or a logical channel.

A low-power wireless sensor with a camera may be desirable in an IoT network. An IoT sensor device can have a camera and a wireless data connection. An IoT sensor device may communicate via modulated light, e.g. solar and/or optical sensor. An IoT sensor device can be powered by magnetics, a battery or light. The light communication sources can be from a modulated backlight of a phone, or via a ceiling light bulb associated with the IoT device. For example, the IoT sensor device can be inside an LED light bulb, or elsewhere. The IoT sensor device can include low power motion sensing technology and may be able to post process and identify objects in the optical field of view. The IoT sensor device can utilize smart processing to extract complex conclusions from the sensor data. The IoT sensor device can pass image data to applications along with other images to extract complex tasks and 3D views, e.g. determining who walked in a room, where they sat down, when they sat down, etc. The IoT network could pass along needs, such as count the number of times someone opened a window. An optical IoT sensor device may include non-visible light spectrum. The IoT sensor devices can be identifiable by electronic signatures, optical signatures (visible or non-visible light spectrum), etc. The IoT sensor device can filter results based on information sensed by proximal sensors. For example, if there are ten people sitting in a room, the temperature determined by the sensor that is closest to the ten people can be self-weighted higher than the temperature determined by the other sensors. The sensor can also be wirelessly powered, e.g. powers up similar to NFC when wireless power transmission (WPT) is present. Similarly, for wearable, or internal sensors, power can be transferred through the body to the sensor to read, e.g. similar to how NFC uses e-fields to read.

In one or more implementations, one or more of the devices 104 A-D can be configured as a control device (e.g., a management device) that perform supervisory task related to the network environment 100. For example, the control device can perform the functionalities such as registration of birth certificates, authentication, validations, and/or reconfiguration of the devices 104 A-D.

Not all of the depicted components of the network environment 100 may be required, and one or more implementations can include additional components not shown in the figure. Variations in the arrangement and types of the components can be made without departing from the spirit or scope of the claims as set forth herein. Additional, different or fewer components can be provided.

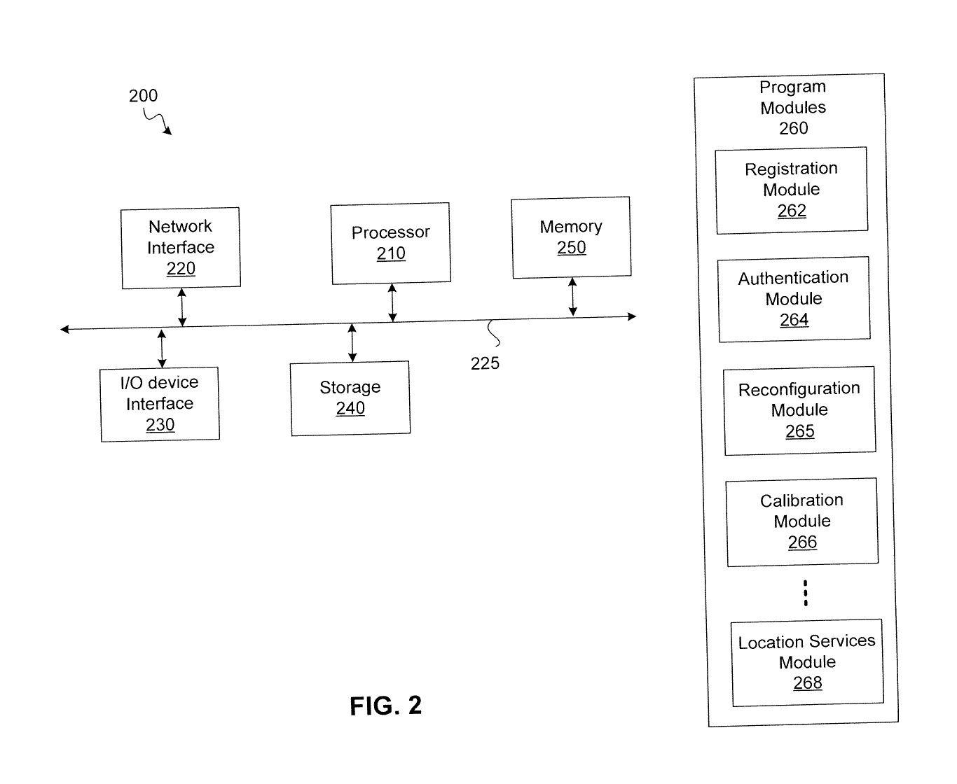

FIG. 2 illustrates an example of a device 200 of a system of interoperable devices in accordance with one or more implementations of the subject technology. The device 200 may represent any of devices 104A-D of FIG. 1. In one or more aspects, the device 200 may represent a control device of the network environment 100 of FIG. 1. In some aspects, the device 200 may include sensors such as temperature sensors, video cameras, motion sensors, audio recorders, humidity sensors, smoke detectors, various gas sensors, radiation monitors, and other sensors.

The device 200 can be a part of or be in communication with a desktop computer, a laptop computer, a tablet computer, a server, a switch, a router, a base station, a receiver, a phone, a personal digital assistant (PDA), or generally any electronic device that transmits signals over a network, such as electronic devices embedded in smart appliances and other smart systems. Such an electronic device may include various types of computer readable media and interfaces for various other types of computer readable media. The device 200 includes, but is not limited to, a bus 225, one or more processing unit(s) (e.g., processor (s)) 210, a storage device (e.g., a permanent storage device) 240, an input/output (I/O) device interface 220, and a network interface 220, or subsets and variations thereof.

The bus 225 collectively represents all system, peripheral, and chipset buses that communicatively connect the numerous internal devices of the device 200. In one or more implementations, the bus 225 communicatively connects the one or more processing unit(s) 210, memory 250, the storage device 240, the network interface 220, and the I/O device interface 230. The memory 250 may include a ROM or a system memory unit, from which the one or more processing unit(s) 210 retrieves instructions to execute and data to process in order to execute the processes of the subject disclosure. The one or more processing unit(s) 210 can be a single processor or a multi-core processor in different implementations. The ROM stores static data and instructions that are needed by the one or more processing unit(s) 210 and other modules of the electronic system. The storage device 240, on the other hand, is a read-and-write memory device. The storage device 240 is a non-volatile memory unit that stores instructions and data even when the device 200 is off. One or more implementations of the subject disclosure use a mass-storage device (such as a magnetic or optical disk and its corresponding disk drive) as the storage device 240. Other implementations use a removable storage device (such as a floppy disk, flash drive, and its corresponding disk drive) as the storage device 240. Like the storage device 240, the system memory unit is a read-and-write memory device. However, unlike the storage device 240, the system memory unit is a volatile read-and-write memory, such as random access memory (RAM). The memory 250 stores any of the instructions and data that the one or more processing unit(s) 210 uses at runtime. In one or more implementations, the processes of the subject disclosure are stored in the memory 250 or the storage device 240 or can be implemented in firmware. From these various memory units, the one or more processing unit(s) 210 retrieves instructions to execute and data to process in order to execute the processes of one or more implementations. The processes of the subject disclosure are included in a number of program modules 260 including, but are not limited to, a registration module 262, an authentication module 264, a reconfiguration module 265, a calibration module 266, and a location services module 268, which can be implemented in software and/or firmware. When implemented in software, the program modules 260 can be executed by a processor (e.g., 210) to implement various processes of the subject technology.

In one or more implementations, the registration module 262 registers a digital birth certificate based on a private key to the device 200 or any other devices such as the devices 104 A-D of FIG. 1. In some aspects, the device 200, which includes the registration module 262 is a trusted authority such as a registrar. The authentication module 264 can authenticate and validate the device 200 or any other devices such as the devices 104 A-D of FIG. 1. The authentication and validation can be performed in the network environment 100 of FIG. 1. In some aspects, the authentication and validation of a device can be revocable. For example, the authenticated holder of the digital birth certificate (e.g., the registrar) can use the authentication module 264 to remotely kill a device, transfer ownership of the device, associate the device with other devices of a network (e.g. in the user's home network). In some instances, the device 200 (e.g., any IoT sensors and/or devices 104 A-D of FIG. 1) can include multiple owners or associated users. The IoT sensors and/or devices can be configured (e.g., by the configuration module 256) such that some tasks require authentication and/or approval from some and/or all owners while other tasks may only require authentication and/or approval from a single owner. The authentication module 264 can remotely revoke ownership of or transfer ownership of a device (e.g., device 200 or any other devices), associate the device with other devices, or change association of the device with one or more of the other devices. In some aspects, the authentication module 264 can perform these tasks based on one or more policies and as part of a registrar or a control or management device (e.g., device 200 is a registrar or a control device).

The reconfiguration module 265 can perform reconfiguration of the device 200 or any other device such as the devices 104 A-D of FIG. 1. The reconfiguration includes a physical reconfiguration, a logical reconfiguration, or reconfiguration of a mode of operation of the device. The physical reconfiguration includes changing configurations, parameters, or variables of the device such that the changes can be permanent (e.g., implemented in hardware such as a ROM). For example, a device can be reconfigured to be associated with a user, be able to function in a specific environment, or have some optional functionality set on or off. The logical configuration, on the other hand, can include non-physical changes that include temporary changes, for example, relating to logical renting of the device, where a renter can rent the data provided by the device.

The reconfiguration of the mode of operation of the device includes, but is not limited to, reconfiguration of a behavior, output data allocation, or an ownership of the device. When performing reconfiguration of the behavior of the device, the reconfiguration module 265 can reconfigure a functionality, a calibration, or an output quality of the device. In some aspects, the reconfiguration of the functionality of the device includes modifying a type or a quality of an output of the device. For example, the device (e.g., device 200) can be a video camera that has a light sensor, a temperature sensor, a barometer, a wind sensor, a motion sensor, and other sensors. The video camera can be a security camera that is reconfigured for a different use such as a weather camera. In this case, the outputs can be reconfigured to include the data from the temperature sensor, the barometer, and the wind sensor. The output quality of the device can be reconfigured to conform to the application, for example, the sensitivity or output signal level of various sensors can be adjusted depending on the application.

The reconfiguration module 265 can dynamically reconfigure the calibration of a device (e.g., 200) based on data provided by one or more other devices 104A-D of FIG. 1, such as sensors in the vicinity of the device 200. For example, if the device 200 is a temperature sensor among multiple temperature sensors operating in a specific environment (e.g., a house) and is reading a temperature that is significantly different from readings of other temperature sensors, then the device 200 can be malfunctioning. In this case, the reconfiguration module 265 can recalibrate or reboot the device 200 or flag the device 200 as malfunctioning and/or lower or reduce to zero the weight of the reading of device 200, when combing the readings of the multiple temperature sensors. These can be done by the reconfiguration module 265 of the device itself or be performed remotely by a reconfiguration module of a control device.

In one or more implementations, the reconfiguration module 265 can reconfigure the ownership of the device by allowing a temporary ownership such as renting of the device. The renting can include physical renting or renting of data provided by the device. For example, a security system including a number of sensors (e.g., motion sensors, cameras, and other sensors) can be physically rented to an entity such as a homeowner. Whereas, a logical renting can include renting the data provided by a number of devices such as environmental sensors (e.g., temperature, pressure, humidity, gas, radiation, and other sensors) to different entities such as individuals, companies, organizations, and/or other users.

The location services module 268 can obtain and/or determine location information of device 200 or any other devices 104 A-D of FIG. 1. The location information can be obtained from a global positioning system (GPS) or determined based on WiFi signals or by using other methods and/or devices, systems, or signals. The location information can be stored in memory 250 or the storage device 240. The location information of the device can be used in reconfiguration and/or recalibration of the device. The location information of the device can also be used when reporting data provided by the device, for example, the climate data (e.g., temperature, humidity, pressure, etc.), the traffic data (e.g., speed, image, distance from neighboring cars, etc.), or security data (e.g., motion, picture, smoke, etc.).

The I/O device interface 230 enables a user to communicate information and select commands to the device 200. Input devices used with the I/O device interface 230 include, for example, alphanumeric keyboards and pointing devices (also called “cursor control devices”). The I/O device interface 230 can further enable, for example, the display of images generated by the device 200. Output devices used with the I/O device interface 230 include, for example, printers and display devices, such as a liquid crystal display (LCD), a light-emitting diode (LED) display, an organic light-emitting diode (OLED) display, a flexible display, a flat panel display, a solid state display, a projector, or any other device for outputting information. One or more implementations can include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, the network interface 220 can include cellular interfaces, WiFi interfaces, Infrared interfaces, radio frequency identification (RFID) interfaces, ZigBee interfaces, Bluetooth interfaces, Ethernet interfaces, coaxial interfaces, optical interfaces, or generally any communication interface that can be used for device communication. The communications can be performed with a network environment such as the network environment 100 of FIG. 1.

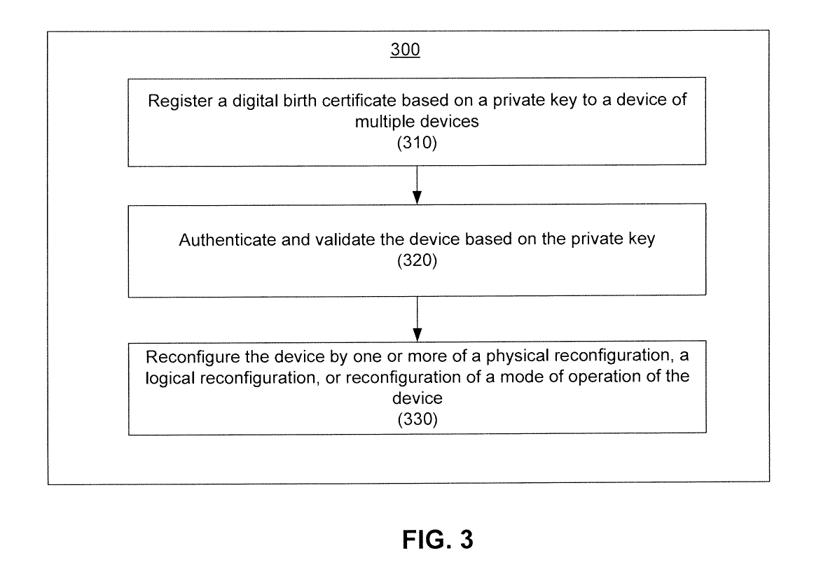

FIG. 3 illustrates an example of a method 300 of managing and reconfiguring a system of interoperable devices in accordance with one or more implementations of the subject technology. For explanatory purposes, the example method 300 is described herein reference to, but is not limited to, the network environment 100 of FIG. 1 and the device 200 of FIG. 2. Further for explanatory purposes, the blocks of the example method 300 are described herein as occurring in serial, or linearly. However, multiple blocks of the example method 300 can occur in parallel. In addition, the blocks of the example method 300 need not be performed in the order shown and/or one or more of the blocks of the example method 300 need not be performed.

In one or more implementations, the method 300 includes registering (e.g., by a registration module 262 of FIG. 2) a digital birth certificate based on a private key to a device (e.g., any of 104 A-D of FIG. 1) of a plurality of devices (e.g., 104 A-D of FIG. 1) (310). Authentication and validation (e.g., by an authentication module 264 of FIG. 2) of the devices can be performed by using the private key (320). Further, the sensors can be reconfigured (e.g., by a reconfiguration module 265 of FIG. 2) by using one or more of a physical reconfiguration, a logical reconfiguration, or reconfiguration of a mode of operation of the sensor (330).

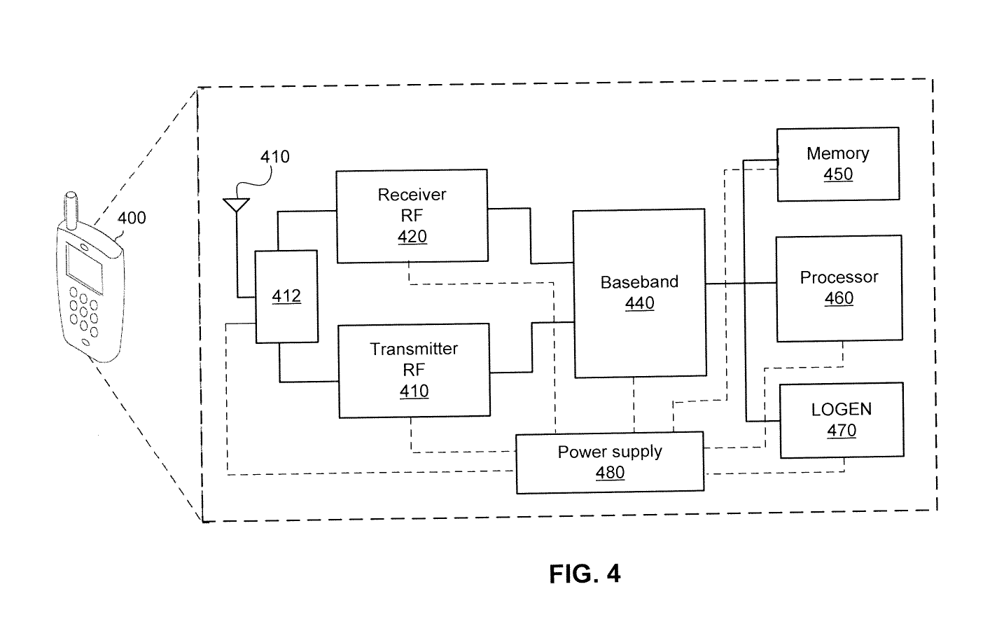

FIG. 4 illustrates an example wireless communication device 400 in accordance with one or more implementations of the subject technology. The wireless communication device 400 can represent a device 104 A-D of FIG. 1, for example, a control device. In one or more aspects, the wireless communication device 400 comprises a radio-frequency (RF) antenna 410, a receiver 420, a transmitter 430, a baseband processing module 440, a memory 450, a processor 460, and a local oscillator generator (LOGEN) 470. In various embodiments of the subject technology, one or more of the blocks represented in FIG. 4 can be integrated on one or more semiconductor substrates. For example, the blocks 420-470 can be realized in a single chip or a single system on chip, or can be realized in a multi-chip chipset.

The RF antenna 410 is suitable for transmitting and/or receiving RF signals (e.g., wireless signals) over a wide range of frequencies. Although a single RF antenna 410 is illustrated, the subject technology is not so limited.

The receiver 420 comprises suitable logic circuitry and/or code that can be operable to receive and process signals from the RF antenna 410. The receiver 420 can, for example, be operable to amplify and/or down-covert received wireless signals. In various embodiments of the subject technology, the receiver 420 can be operable to cancel noise in received signals and can be linear over a wide range of frequencies. In this manner, the receiver 420 can be suitable for receiving signals in accordance with a variety of wireless standards. Wi-Fi, WiMAX, Bluetooth, and various cellular standards. In various embodiments of the subject technology, the receiver 420 does not require any SAW filters and few or no off-chip discrete components such as large capacitors and inductors.

The transmitter 430 includes suitable logic circuitry and/or code that can be operable to process and transmit signals from the RF antenna 410. The transmitter 430 can, for example, be operable to up-covert baseband signals to RF signals and amplify RF signals. In various embodiments of the subject technology, the transmitter 430 can be operable to up-convert and amplify baseband signals processed in accordance with a variety of wireless standards. Examples of such standards include Wi-Fi, WiMAX, Bluetooth, and various cellular standards. In various embodiments of the subject technology, the transmitter 430 can be operable to provide signals for further amplification by one or more power amplifiers.

The duplexer 412 can provide isolation in the transmit band to avoid saturation of the receiver 420 or damaging parts of the receiver 420, and to relax one or more design requirements of the receiver 420. Furthermore, the duplexer 412 can attenuate the noise in the receive band. The duplexer can be operable in multiple frequency bands of various wireless standards.

The baseband processing module 440 comprises suitable logic, circuitry, interfaces, and/or code that can be operable to perform processing of baseband signals. The baseband processing module 440 can, for example, analyze received signals and generate control and/or feedback signals for configuring various components of the wireless communication device 400 such as the receiver 420. The baseband processing module 440 can be operable to encode, decode, transcode, modulate, demodulate, encrypt, decrypt, scramble, descramble, and/or otherwise process data in accordance with one or more wireless standards.

The processor 460 comprises suitable logic, circuitry, and/or code that can enable processing data and/or controlling operations of the wireless communication device 400. In this regard, the processor 460 can be enabled to provide control signals to various other portions of the wireless communication device 400. The processor 460 can also control transfers of data between various portions of the wireless communication device 400. Additionally, the processor 460 can enable implementation of an operating system or otherwise execute code to manage operations of the wireless communication device 400.

The memory 450 comprises suitable logic, circuitry, and/or code that can enable storage of various types of information such as received data, generated data, code, and/or configuration information. The memory 450 comprises, for example, RAM, ROM, flash, and/or magnetic storage. In various embodiment of the subject technology, Information stored in the memory 450 can be utilized for configuring the receiver 420 and/or the baseband processing module 440.

The local oscillator generator (LOG EN) 470 comprises suitable logic, circuitry, interfaces, and/or code that can be operable to generate one or more oscillating signals of one or more frequencies. The LOGEN 470 can be operable to generate digital and/or analog signals. In this manner, the LOGEN 470 can be operable to generate one or more clock signals and/or sinusoidal signals. Characteristics of the oscillating signals such as the frequency and duty cycle can be determined based on one or more control signals from, for example, the processor 460 and and/or or the baseband processing module 440. In operation, the processor 460 can configure the various components of the wireless communication device 400 based on a wireless standard according to which it is desired to receive signals. Wireless signals can be received via the RF antenna 410 and amplified and down-converted by the receiver 420. The baseband processing module 440 can modulate, encode and perform other processing on audio, video, and/or control signals to be transmitted by the transmitter 430 in accordance to various wireless standards.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, and methods described herein can be implemented as electronic hardware, computer software, or combinations of both. To illustrate this interchangeability of hardware and software, various illustrative blocks, modules, elements, components, and methods have been described above generally in terms of their functionality. Whether such functionality is implemented as hardware or software depends upon the particular application and design constraints imposed on the overall system. Skilled artisans can implement the described functionality in varying ways for each particular application. Various components and blocks can be arranged differently (e.g., arranged in a different order, or partitioned in a different way) all without departing from the scope of the subject technology.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as “an aspect” does not imply that such aspect is essential to the subject technology or that such aspect applies to all configurations of the subject technology. A disclosure relating to an aspect can apply to all configurations, or one or more configurations. An aspect can provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method for managing and reconfiguring a plurality of devices of a network, the method comprising:
registering a digital birth certificate based on a private key to a device of the plurality of devices;
authenticating and validating the device of the plurality of devices based on the private key; and
reconfiguring the device of the plurality of devices, wherein the reconfiguring comprises at least one of a physical reconfiguration, a logical reconfiguration, or reconfiguration of a mode of operation of the device.

2. The method of claim 1, wherein the plurality of devices comprises a plurality of sensors, and wherein the method further comprises obtaining location information of at least some of the plurality of sensors and storing the location information.

3. The method of claim 1, wherein the reconfiguration of the mode of operation of the device includes reconfiguration of at least one of a behavior, output data allocation, or an ownership of the device.

4. The method of claim 3, wherein reconfiguration of the behavior of the device comprises reconfiguration of at least one of functionality, a calibration, or an output quality of the device, and wherein reconfiguration of the functionality of the device comprises modifying at least one of a type or a quality of an output of the device.

5. The method of claim 3, wherein reconfiguration of the ownership of the device comprises allowing a temporary ownership such as renting including physical renting or renting of data provided by the device.

6. The method of claim 4, wherein reconfiguration of the calibration of the device comprises recalibrating the device based on data provided by one or more other devices of the plurality of device.

7. The method of claim 1, wherein authenticating and validating the device comprises facilitating authentication and validation of the device in a network environment including the Internet or a private network, and wherein the authentication and validation of the device is revocable.

8. The method of claim 1, further comprising remotely revoking ownership of or transferring ownership of a device of the plurality of devices, associating a device of the plurality of devices with other devices, or changing association of the device with one or more of the other devices by a registrar based on one or more policies.

9. The method of claim 1, wherein registering at least one of the digital birth certificate to, authenticating and validating, or reconfiguring the device of the plurality of devices is self-performed by the device of the plurality of devices.

10. A system for managing and reconfiguring a plurality of devices of a network, the system comprising:
a first device configured to register a digital birth certificate based on a private key to a device of the plurality of devices;
a second device configured to authenticate and validate the device of the plurality of devices based on the private key; and
a third device configured to reconfigure the device of the plurality of devices, wherein reconfiguring comprises at least one of a physical reconfiguration, a logical reconfiguration, or reconfiguration of a mode of operation of the device.

11. The system of claim 10, wherein the plurality of devices comprises a plurality of sensors, wherein the network comprises the Internet of Things (IoT), wherein the functionalities of at least two of the first, second, or third devices are combined and performed by a control device.

12. The system of claim 10, wherein the system is further configured to obtain location information of at least some of the plurality of sensors and to store the location information, wherein the third device is configured to perform reconfiguration of the mode of operation of the device by reconfiguring at least one of a behavior, output data allocation, or an ownership of the device.

13. The system of claim 12, wherein the third device is configured to perform reconfiguration of the behavior of the device by reconfiguring at least one of functionality, a calibration, or an output quality of the device, and wherein the third device is configured to perform reconfiguration of the functionality of the device by modifying at least one of a type or a quality of an output of the device.

14. The system of claim 12, wherein the third device is configured to perform reconfiguration of the ownership of the device by allowing a temporary ownership such as renting including physical renting or renting of data provided by the device.

15. The system of claim 13, wherein the third device is configured to perform reconfiguration of the calibration of the device by recalibrating the device based on data provided by one or more other devices of the plurality of device.

16. The system of claim 10, wherein the second device is configured to perform authentication and validation of the device by facilitating authentication and validation of the device in a network environment including the Internet or a private network, and wherein the authentication and validation of the device is revocable.

17. The system of claim 10, wherein the system further comprises a registrar that is configured to remotely revoke ownership of or to transfer ownership of a device of the plurality of devices, to associate a device of the plurality of devices with other devices, or to change association of the device with one or more of the other devices based on one or more policies, and wherein the registrar comprises at least one of the first or the second devices.

18. The system of claim 10, wherein the device of the plurality of devices is configured to self-perform at least one of registering the digital birth certificate to, authenticating and validating, or reconfiguring the device of the plurality of devices.

19. A system for managing and reconfiguring a plurality of devices of a network, the system comprising:
memory;
one or more processors coupled to the memory and configured to execute one or more program modules to perform:
registering a digital birth certificate based on a private key to a device of the plurality of devices;
authenticating and validating the device of the plurality of devices based on the private key; and
reconfiguring the device of the plurality of devices, wherein reconfiguring comprises at least one of a physical reconfiguration, a logical reconfiguration, or reconfiguration of a mode of operation of the device of the plurality of devices.

20. The system of claim 19, wherein:
the reconfiguration of the mode of operation of the device includes reconfiguration of at least one of a behavior, output data allocation, or an ownership of the device,
reconfiguration of the behavior of the device comprises reconfiguration of at least one of functionality, a calibration, or an output quality of the device,
reconfiguration of the functionality of the device comprises modifying at least one of a type or a quality of an output of the device,
reconfiguration of the ownership of the device comprises allowing a temporary ownership such as renting including physical renting or renting of data provided by the device, and
reconfiguration of the calibration of the device comprises recalibrating the device based on data provided by one or more other devices of the plurality of device.
